(19) United States
(12) Patent Application Publication
(10) Pub. No.: US 2017/0272705 A1
(43) Pub. Date: Sep. 21, 2017

(54) MULTIMEDIA PLAYING SYSTEM FOR AUTOMATICALLY NOTIFYING ABNORMAL SITUATIONS AND INFORMATION PROCESSING METHOD OF THE SAME

(71) Applicant: Insyde Software Corp., Taipei City (TW)

(72) Inventors: Chih Kao Wang, Taipei City (TW); Chia-Ting Yu, Taipei City (TW); Tang Wei Jung, Taipei City (TW)

(21) Appl. No.: 15/455,297

(22) Filed: Mar. 10, 2017

(30) Foreign Application Priority Data
Mar. 17, 2016 (TW) 105108234

(51) Int. Cl. H04N 7/18; H04N 7/015; H04N 7/10; H04L 12/58

(52) U.S. Cl. CPC H04N 7/183; H04L 51/04; H04L 51/18; H04N 7/015; H04N 7/10

(57) ABSTRACT

A multimedia playing system for automatically notifying abnormal situations has a TV dongle and a network security camera connected to the TV dongle through network. The TV dongle has an email processing server module. The network security camera has an email transmitting module. When the network security camera detects an abnormal situation, an event message is transmitted to the email processing server module. The email processing server module accordingly generates a command. According to the command, the TV dongle transmits a control signal to control a digital TV to immediately display the abnormal situation. Therefore, the multimedia playing system automatically informs a user of the occurrence of the normal situation.

### BACKGROUND OF THE INVENTION

1. Field of the Invention

The present invention relates to a multimedia playing system, and more particularly to a multimedia playing system for automatically notifying abnormal situations and an information processing method of the same.

2. Description of the Prior Arts

With the development of science and technology, multimedia system is popular worldwide in people's lives. The multimedia system may include a variety of electronic devices such as a digital TV, a CD player, a video game console and so forth. The digital TV may be in connection with other electronic equipment for entertainment activities.

As the people attach importance to home security, a network monitoring system is also widely applied for home security surveillance. To handle abnormal situations of the surroundings, the user may connect a network security camera of the network monitoring system to the digital TV for displaying detected results of the network security camera on the digital TV.

With reference to FIG. 4, a monitoring system may comprise a network security camera 90, a display 91 and a cloud server 92. The network security camera 90 is connected to the display 91 and linked to the cloud server 92 via a network. The network security camera 90 monitors situations of the surroundings. The display 91 is configured to show selectable channels and input video sources so that users can check different zones of the surroundings. The cloud server 92 is configured to receive a warning message transmitted from the network security camera 90. To check whether the network security camera 90 detects an abnormal situation, the users need to have a mobile device or a computer and connect the mobile device or the computer to the cloud server 92. Furthermore, the users still need to select a proper channel or an input video source of the display 91 to check detail of the abnormal situation.

Although the network security camera 90 sends the warning message to the cloud server 92, it is inconvenient for users to obtain real-time notifications of the situations of the surroundings. The users still need to log in the cloud server 92 to check the detected situations. In other words, the users will not become aware of the occurrence of the abnormal situation if they do not log in the cloud server 92 through using the mobile device or the computer. Furthermore, while the display 91 is showing TV programs, the abnormal situation is unable to be immediately recognized.

### SUMMARY OF THE INVENTION

An objective of the present invention is to provide an information processing method of a multimedia playing system for automatically notifying abnormal situations, wherein a TV dongle receives an event message transmitted by a network security camera and analyzes the event message to generate a control signal for controlling a digital device, thus informing a user of the occurrence of an abnormal situation.

To achieve the objective, the multimedia playing system comprising a TV dongle connected with at least one network security camera through a network, the method performed by the TV dongle comprises the steps of:

receiving an event message transmitted from the at least one network security camera using a simple mail transfer protocol SMTP through the network, and

analyzing the event message and accordingly generating a command.

When the TV dongle receives the event message from the network security camera and analyzes the event message, a command is generated for controlling a digital TV in connection with the TV dongle to perform a corresponding operation. Therefore, if there is any abnormal situation, the user can be informed.

The multimedia playing system for automatically notifying abnormal situations has:

at least one network security camera having an email transmitting module, wherein the at least one network security camera monitors surroundings, and the email transmitting module, according to an abnormal situation of the surroundings, transmits an event message using Simple Mail Transfer Protocol (SMTP); and

a TV dongle connected to the at least one network security camera through a network and having an email processing server module and a first transceiving module, wherein the email processing server module receives and analyzes the event message to generate a command to the first transceiving module, and the first transceiving module generates a control signal according to the command

By plugging the TV dongle to a digital TV, when the network security camera detects an abnormal situation, the email transmitting module transmits the event message to the email processing server module of TV dongle, and the email processing server module analyzes the event message to generate the command to the first transceiving module. The first transceiving module generates the control signal to control a digital TV to perform a corresponding operation such as switching channels or starting video recording for informing a user of the occurrence of the abnormal situation. By automatically informing the user, the original operation of the digital TV can be interrupted, and the user can immediately obtain the abnormal situation from the digital TV.

### BRIEF DESCRIPTION OF THE DRAWINGS

FIG. 1 is a block diagram of a multimedia playing system for automatically notifying abnormal situations of the present invention;

FIG. 2 is a flow chart of an information processing method of the present invention;

FIG. 3 is a flow chart of another embodiment of the information processing method of the present invention; and

FIG. 4 is a block diagram of a conventional monitoring system.

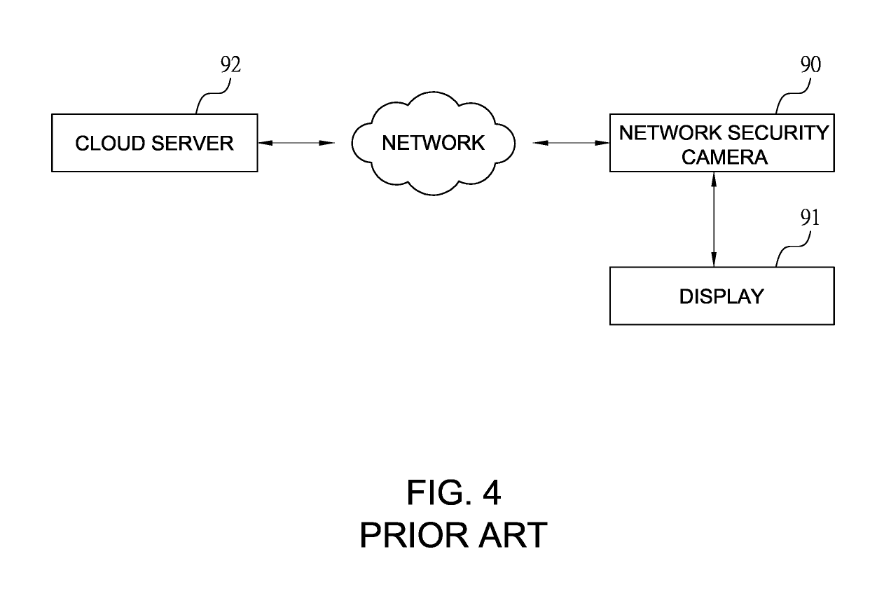

### DETAILED DESCRIPTION OF THE INVENTION

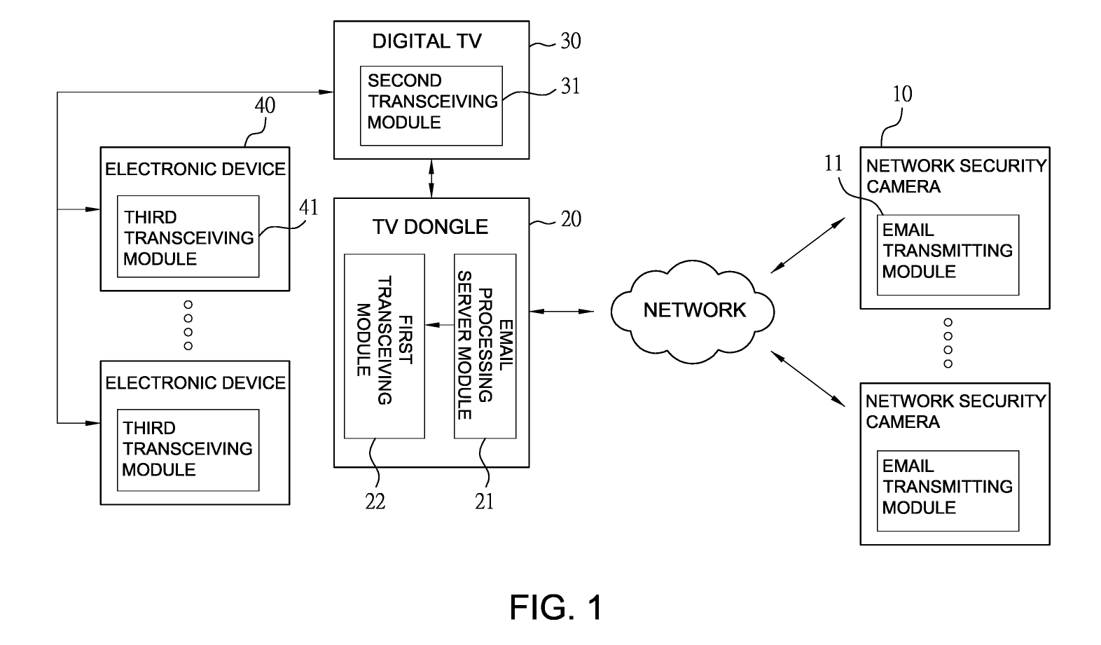

With reference to FIG. 1, a multimedia playing system for automatically notifying abnormal situations of the present invention provides a TV dongle 20 connecting to at least one network security camera 10 via a network. In this embodiment, the multimedia playing system further has a digital TV 30 and one or more electronic devices 40. The digital TV 30 is to be connected by the TV dongle 20 and is capable of connecting to each of the electronic devices 40. Preferably, the TV dongle 20 and each of the at least one network security camera 10 are configured in the same local area network.

Each of the at least one network security camera 10 has an email transmitting module 11 and is used to monitor surroundings. When an abnormal situation occurs, for example a person passing through the network security camera 10 or the network security camera 10 being moved, the at least one network security camera 10 will generate information about abnormality and the email transmitting module 11 will, according to the information about abnormality, send an event message using the Simple Mail Transfer Protocol (SMTP) to the TV dongle 20 via a network. Prior to the practical use of each of the at least one network security camera 10, a network address corresponding to the TV dongle 20 should be designated in each of the at least one network security camera 10 so that the email transmitting module 11 can send the event message to the TV dongle 20. The SMTP is a relatively simple and text-based protocol capable of sending messages to one or more designated recipients.

The TV dongle 20 has an email processing server module 21 and a first transceiving module 22 connected to the email processing server module 21. Upon receipt of the event message, the email processing server module 21 analyzes the event message and accordingly outputs a command to the first transceiving module 22. The first transceiving module 22 generates a control signal based on the command for controlling the digital TV 30 or the electronic devices 40 to perform a corresponding operation. In this embodiment, the first transceiving module 22 is a high definition multimedia interface (HDMI) for transmission of uncompressed audio signals, video signals or control signals. The first transceiving module 22 meets the consumer electronics control (CEC) protocol for transmitting and receiving industrial standard control signals so that a single remote control is able to control a plurality of digital TVs and electron devices. Using the HDMI, the TV dongle 20 supports a hot plugging connection to a corresponding HDMI on the digital TV 30.

In this embodiment, after the TV dongle 20 generates the control signal based on the command, the TV dongle 20 still continuously monitors whether any of the at least one network security camera 10 sends out a new event message. If the new event message is received, the TV dongle 20 will generate a new command corresponding to the new event message for further controlling the digital TV 30 or the electronic devices 40.

In this embodiment, the TV dongle 20 may analyze the event message using one of the following two ways, but other ways for analyzing the event message are possible and not excluded. The first way for analyzing the event message may be implemented by learning or training. When the at least one network security camera 10 outputs a first type of the event message, the email processing server module 21 will accordingly generate a first type of command. Similarly, when the at least one network security camera 10 outputs a second type of the event message, the email processing server module 21 will accordingly generate a second type of command. In other words, the email processing server module 21 learns the types of commands for different types of event messages. Therefore, the TV dongle 20 can output the same command for the same type of event messages even though the event messages are sent from network security cameras of different manufacturers. The second way for analyzing the event message uses the email processing server module 21 to capture mail subject or keywords in content of the event message for generating a corresponding command, whereby the TV dongle 20 can be used in association with network security cameras of different manufacturers.

The digital TV 30 is to be connected by the TV dongle 20 and comprises a second transceiving module 31 to receive the control signal output from the TV dongle 20. The digital TV 30 will be operated in response to the control signal received by the second transceiving module 31. For example, when the TV dongle 20 generates a first control signal based on the command, the first transceiving module 22 transmits the first control signal to the second transceiving module 31 of the digital TV 30 using the CEC protocol to control the digital TV 30 to perform the corresponding operation. In this embodiment, the corresponding operations may include actions such as switching channels, turning on a monitor of the digital TV 30, or displaying a message. The message displayed by the digital TV 30 may be online screen display (OSD) information. The second transceiving module 31 is also an HDMI that meets the Consumer Electronics Control (CEC) protocol for transmitting and receiving industrial standard control signals.

The electronic devices 40 are connected to the digital TV 30. Each of the electronic devices 40 comprises a third transceiving module 41 for receiving the control signal generated by the TV dongle 20 through the digital TV 30. When the TV dongle 20 generates a second control signal based on the command and transmits the second control signal from the first transceiving module 22 to the digital TV 30 using the CEC protocol, the second transceiving module 31 transmits the second control signal using the CEC protocol to the third transceiving module 41 of one of the electronic devices 40 to control the electronic device 40 for performing a corresponding operation. In this embodiment, the electronic devices 40 may be video recorders, video game consoles or other digital TVs and so forth. The corresponding operation performed by the electronic devices 40 may include an action of starting video recording, stopping video games, and turning on a screen of the electronic device. The third transceiving module 41 is also an HDMI that meets the Consumer Electronics Control (CEC) protocol for transmitting and receiving industrial standard control signals.

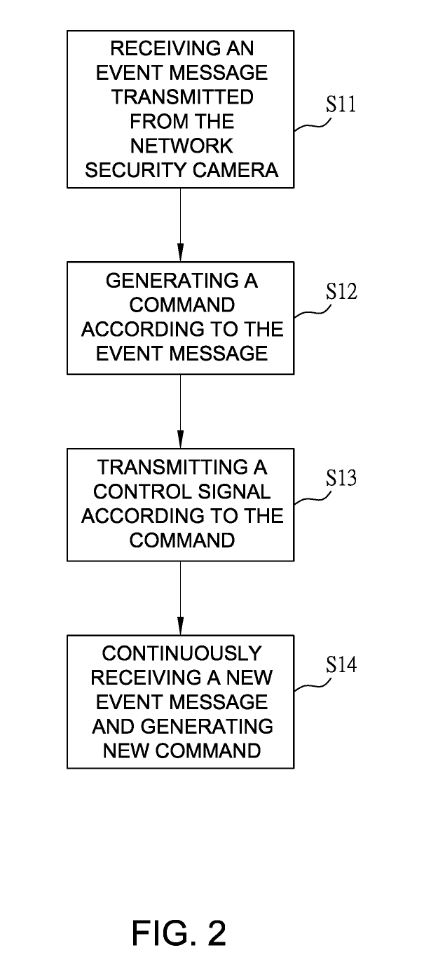

Based on the foregoing descriptions, an information processing method for automatically notifying abnormal monitoring situations is illustrated in FIG. 2. The information processing method may be applied to a multimedia playing system including at least one network security camera 10 connected to a TV dongle 20 through a network, wherein each of the at least one network security camera 10 has an email transmitting module 11 and the TV dongle 20 has an email processing server module 21 and a first transceiving module 22. The information processing method implemented by the TV dongle 20 comprises the steps of

receiving an event message transmitted from the network security camera 10 using the simple mail transfer protocol (SMTP) over the network (S11);

analyzing the event message and accordingly generating a command (S12);

generating a control signal corresponding to the command (S13); and

continuously receiving new event messages for generating new commands (S14).

When a digital TV 30 having a second transceiving module 31 is further provided and connected with the TV dongle 20, the method further comprises steps of:

generating a first control signal by the first transceiving module 22 of the TV dongle 20 according to the command, and transmitting the first control signal from the first transceiving module 22 of the TV dongle 20 to the second transceiving module 31 of the digital TV 30 using the CEC protocol for controlling the digital TV 30 to perform a corresponding operation.

When an electronic device 40 having a third transceiving module 41 is further provided and connected with the digital TV 30, the method further comprises steps of:

generating a second control signal by the first transceiving module 22 of the TV dongle 20 according to the command, transmitting the second control signal from the first transceiving module 22 of the TV dongle 20 to the second transceiving module 31 of the digital TV 30 using the CEC protocol, and further transmitting the second control signal from the second transceiving module 31 of the digital TV 30 to the third transceiving module 41 of the electronic device 40 for controlling the electronic device 40 to perform a corresponding operation.

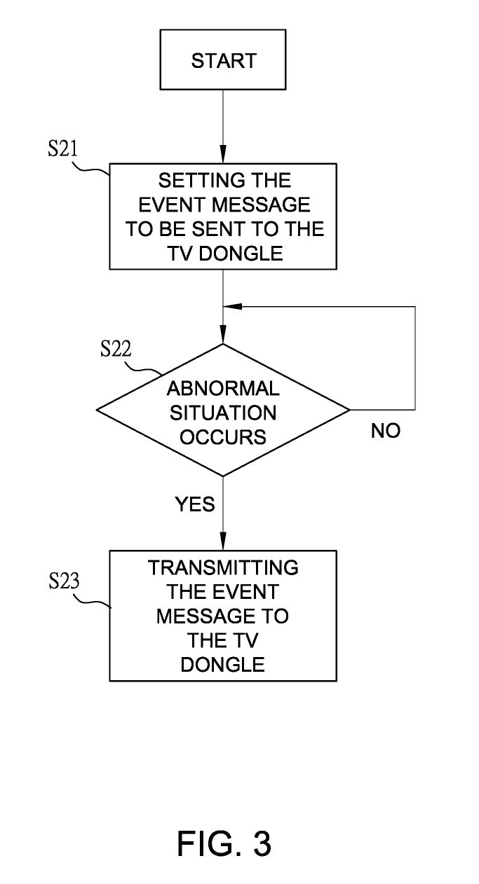

Before the network security camera 10 executes the step (S11), a setting process for the network security camera 10 may be performed. With reference to FIG. 3, the setting process comprises the steps of:

configuring the email transmitting module 11 of the network security camera 10 to correspond to the TV dongle 20 so that the event message can be delivered to the TV dongle (S21); wherein the TV dongle 20 may be configured to have a network address such as 192.0.0.1, and the network security camera 10 is set to correspond to the network address of the TV dongle 20 so that the email transmitting module 11 can transmit the event message to the TV dongle 20;

the network security camera 10 monitoring the surroundings to determine whether the abnormal situation occurs (S22); and

when the abnormal situation occurs, the email transmitting module 11 transmitting the event message according to information about abnormality to the TV dongle 20 (S23); wherein the network security camera 10 will continuously monitor the surroundings and transmit a new event message to the TV dongle 20 when a new abnormal situation is detected.

Because the email processing server module 21 is provided in the TV dongle 20, the event message from the network security camera 10 can be processed in real time. The TV dongle 20 generates the first control signal according to the event message and transmits the first control signal through the first transceiving module 22 for controlling the digital TV 30 to perform a corresponding operation. Alternatively, the TV dongle 20 generates the second control signal according to the event message and transmits the second control signal to the electronic device 40 to perform a corresponding operation. Therefore, the user can be immediately informed that there is an abnormal situation while using the digital TV 30 or the electronic device 40.

What is claimed is:

1. An information processing method of a multimedia playing system for automatically notifying abnormal situations, the multimedia playing system comprising a TV dongle connected with at least one network security camera through a network, the method comprising steps of:
(a) receiving an event message transmitted from the at least one network security camera using a simple mail transfer protocol (SMTP) through the network, wherein the event message is generated according to an abnormal situation of surroundings detected by the at least one network security camera; and
(b) analyzing the event message and accordingly generating a command so that a digital TV connected to the TV dongle performs a corresponding operation for checking the abnormal situation.

2. The method as claimed in claim I further comprising:
outputting a first control signal, by using a consumer electronics control (CEC) protocol, based on the command for controlling the digital TV.

3. The method as claimed in claim 2, wherein the digital TV is connected with an electronic device, and the method further comprises:
outputting a second control signal, by using the CEC protocol, based on the command for controlling the electronic device.

4. The method as claimed in claim 1, before the step (a), the method further comprise steps executed by the at least one network security camera as follows:
designating the event message to be transmitted to the TV dongle;
monitoring the surroundings to determine whether the abnormal situation occurs; and
when the abnormal situation occurs, transmitting the event message according to information of abnormality generated by the abnormal situation to the TV dongle.

5. The method as claimed in claim 4, wherein the at least one network security camera continuously monitors the surroundings to determine whether a new abnormal situation occurs, and transmits a new event message corresponding to the new abnormal situation to the TV dongle when the new abnormal situation occurs.

6. The method as claimed in claim 1, wherein the TV dongle continuously determines whether a new event message is transmitted from the at least one network security camera, and when the TV dongle receives the new event message, the TV dongle analyzes the new event message and accordingly generates a new command.

7. The method as claimed in claim 2, wherein the TV dongle continuously determines whether a new event message is transmitted from the at least one network security camera, and when the TV dongle receives the new event message, the TV dongle analyzes the new event message and accordingly generates a new command.

8. The method as claimed in claim 3, wherein the TV dongle continuously determines whether a new event message is transmitted from the at least one network security camera, and when the TV dongle receives the new event message, the TV dongle analyzes the new event message and accordingly generates a new command.

9. The method as claimed in claim 4, wherein the TV dongle continuously determines whether a new event message is transmitted from the at least one network security camera, and when the TV dongle receives the new event message, the TV dongle analyzes the new event message and accordingly generates a new command.

10. The method as claimed in claim 5, wherein the TV dongle continuously determines whether a new event message is transmitted from the at least one network security camera, and when the TV dongle receives the new event message, the TV dongle analyzes the new event message and accordingly generates a new command.

11. A multimedia playing system for automatically notifying abnormal situations, the multimedia playing system comprising:
at least one network security camera having an email transmitting module, wherein the at least one network security camera monitors surroundings, and the email transmitting module, according to an abnormal situation of the surroundings, transmits an event message using Simple Mail Transfer Protocol (SMTP); and
a TV dongle connected to the at least one network security camera and having an email processing server module and a first transceiving module, wherein the email processing server module receives and analyzes the event message to generate a command to the first transceiving module, and the first transceiving module generates a control signal according to the command for controlling a digital TV in connection with the TV dongle to perform a corresponding operation for checking the abnormal situation.

12. The system as claimed in claim 11, wherein the digital TV comprises a second transceiving module; the TV dongle generates a first control signal according to the command, the first transceiving module transmits the first control signal to the second transceiving module using the consumer electronics control (CEC) protocol for control the digital TV to perform the corresponding operation.

13. The system as claimed in claim 11, wherein the system further comprises an electronic device, the digital TV is further connected to the electronic device and has a second transceiving module, the electronic device has a third transceiving module, the TV dongle generates a second control signal according to the command, the first transceiving module transmits the second control signal to the second transceiving module using the consumer electronics control (CEC) protocol, and the second transceiving module further transmits the second control signal to the third transceiving module of the electronic device using the CEC protocol for controlling the electronic device to perform a corresponding operation.

14. The system as claimed in claim 11, wherein the first transceiving module is a high definition multimedia interface (HDMI).

15. The system as claimed in claim 12, wherein the first transceiving module is a high definition multimedia interface (HDMI).

16. The system as claimed in claim 13, wherein the first transceiving module is a high definition multimedia interface (HDMI).
